(19) United States
(12) Patent Application Publication
(10) Pub. No.: US 2007/0218329 A1
(43) Pub. Date: Sep. 20, 2007

(54) Combinatorial method and apparatus for screening electrochemical materials

(76) Inventors: Kepler Douglas Keith, Belmont, CA (US); Hashmat Haidari, Foster City, CA (US); Yu Wang, Foster City, CA (US); Richard Sears, Livermore, CA (US)

Correspondence Address: Keith D. Kepler, Ste. 205, 23575 Cabot Blvd., Hayward, CA, 94545, US

(21) Appl. No.: 11/801,847

(22) Filed: May 11, 2007

Related U.S. Application Data
(63) Continuation-in-part of application No. 11/175,555, filed on Jul. 5, 2005.
(60) Provisional application No. 60/799,564, filed on May 11, 2006.

(51) Int. Cl. H01M 8/04; G01N 27/26; G01F 1/64

(52) U.S. Cl. 429/24; 204/400; 205/775

(57) ABSTRACT

The present invention provides an apparatus and method to combinatorially screen a plurality of electrochemical material compositions for use in an electrochemical cell such as a fuel cell, battery or electro-catalytic cell. The apparatus includes an electrochemical cell with one or more windows, sealed with an infrared (IR) transparent material for direct thermal imaging of an internal electrode, an electronic load for applying a voltage or current to the electrochemical cell, and a device, external to the cell, for monitoring the relative temperature of the internal electrode through each window of the cell when the load is applied. When a load is applied to the cell, the temperature observed through each window may be used as a relative measure of the electrochemical efficiency of the discreet region of the electrode being viewed and of the material compositions contained therein. The electrochemical cell may comprise discreet compositions of electrode materials. The device for monitoring the temperature of the cells may include a thermal imaging device, infrared camera and array of thermocouples.

### RELATED APPLICATIONS

This patent claims the benefit of Provisional Patent Application Ser. No. 60/799,564, filed May 11, 2006, the disclosure of which is herein incorporated by reference in its entirety.

### FEDERALLY SPONSORED RESEARCH

The invention was made under support of the United States Government, Department of Energy, Small Business Innovative Research Grant Number DE-FG02-03ER83656. The United States has certain rights in the invention.

### SEQUENCE LISTING OR PROGRAM

Not Applicable

### FIELD OF THE INVENTION

The present invention relates to an electrochemical screening method and apparatus for the evaluation of electrochemical materials and components using a single voltage source. More particularly, this invention relates to a highly parallel apparatus and method for screening electrochemical materials or for evaluating the uniformity of electrodes of a single composition based on relative electrochemical efficiency characteristics by simultaneously monitoring the temperature change of discreet electrochemical regions across a single electrode arising from power losses during the application of an electrical load.

### BACKGROUND OF THE INVENTION

Electrochemical reactions form the basis of many important commercial applications. For example, batteries and fuel cells utilize electrochemical reactions to convert the dormant energy stored in chemical reactants into electricity. Additionally, several large-scale synthetic processes involve electrochemical reactions including the electrolysis of salts or solutions to produce elemental forms of active materials such as aluminum, lithium and sodium. In each of these types of applications, the performance and thus the value of the device or process is limited by the materials used. In particular, it is highly desirable that the application or process be highly efficient, thus maximizing energy conversion in the case of batteries and fuel cells and minimizing energy costs in the case of electrolytic processes.

Applications and processes that have poor electrochemical efficiency suffer losses of much of the available or supplied energy in the form of heat generation according to the equation ΔH=PΔt=i²RΔt, where R is the effective resistance of the cell, i is the current density, P is the power loss and Δt is time. Thus more energy is lost to heat generation when operating an inefficient electrochemical process relative to a more efficient process. In the case of a battery or fuel cell, a more efficient device will exhibit greater power density and greater energy density, particularly when the power demand is high. In fact, much of the design and cost of a battery or fuel cell system, particularly for large, high-power systems used in applications such as electric and hybrid electric or fuel cell vehicles, involves the minimization and management of heat generated by the system during operation.

The efficiency of an electrochemical process or device is dependent on many factors. These factors include the design of the electrochemical cell, the materials used to make the cell, the kinetics of the reactions occurring in the cell, and the multiple interactions of the various materials comprising the cell. To obtain a truly accurate measure of the performance potential of a specific electrochemical material composition, it is critical that all of these issues and interactions are part of the testing environment. For example in a Li-ion battery, the efficiency of the battery can be affected by a number of factors including the kinetics of the intercalation reaction at both the anode and cathode, the electrical conductivity of the anode and cathode, the porosity of the anode and cathode electrodes, the conductivity of the electrolyte, or the porosity of the separator among other factors. In a fuel cell, the efficiency of energy conversion can be greatly affected by the catalyst over-potential, which must be minimized, electrode composition and fuel distribution.

Thus, it is highly desirable to evaluate new electrochemical material candidates in a conventional cell that provides a testing environment similar to that for which the material is intended. This can be particularly important for systems in which interactions between the anode and cathode chemistry can affect the material performance. Such phenomena are common in both battery and fuel cell systems. For a battery or fuel cell a conventional cell commonly comprises a membrane tightly sandwiched between two electrodes; an anode at which oxidation occurs, and a cathode at which reduction occurs. An electrolyte for ion conduction is shared by the anode and cathode.

Because of the importance of the testing environment most electrochemical materials development is still done in series, where individual cells are made for each material and evaluated utilizing a single electronic load or cycler channel for each cell. Traditional current-voltage methods are employed to probe the performance of the materials over long periods of time, requiring large numbers of cycler channels, electronic loads and monitoring equipment. For example, one of the key performance criteria for hybrid electric vehicle batteries and fuel cells is that the there be little change in the resistance or efficiency of the device over the 10-15 year life of the application. Such long-term performance requirements make serial development of materials for such applications extremely difficult and costly since in many cases a single channel could potentially be occupied for months if not years simply to evaluate one material composition or cell design.

Predictive calculation and modeling of the performance of new electrochemical materials could mitigate some of the development burden. Unfortunately, many interfacial electro-catalytic reactions, such as those on which a hydrogen fuel cell is based, are very complex and not readily predisposed to rational catalyst design and many of the factors that affect the life of a battery or fuel cell are not well understood and thus difficult to accurately model. As a result, it can be a very time consuming process to discover and optimize new, more efficient electrochemical material compositions by conventional methods. A combinatorial approach to materials discovery, in which many compositions can be evaluated simultaneously and accurately, can be greatly beneficial to this process, and can be very valuable to the battery, fuel cell and electrolytic industries.

A number of methods have already been developed to screen various electrochemical materials combinatorially. Most of these methods involve the creation of arrays of electrodes or electrochemical cells on a single substrate, each individually addressable by an isolated electrical connection. Examples include U.S. Pat. No. 6,187,164 and US Published Patent Application Nos. 2002/028456 and 2003/0070917. While semiconductor processing methods have allowed large arrays to be made on very small substrates, testing of the materials still require a large number of electrochemical testing channels to probe each electrode by conventional voltage-current techniques. Furthermore, the electrode array structures generally do not allow for the design of electrochemical testing conditions that accurately simulate the environment in which the material will be utilized. For example, the members of the electrode array are commonly tested under half-cell conditions in a flooded cell environment. Semiconductor processing methods have also been used to make similar material arrays for testing a variety of non-electrochemical processes. For example, thermal imaging of sputter deposited alloys has been used as a probe of conventional catalytic reactions, as disclosed in published international application WO 99/34206, and of phase changes of materials, as disclosed in U.S. Pat. No. 6,536,944.

A conventional fuel cell device has been developed that can test multiple fuel cell catalysts in parallel against a common electrode to ensure more accurate comparison and evaluation of the catalyst samples. This device also uses conventional voltage and current techniques to probe performance and requires individual current monitoring channels for each electrochemical sample, as disclosed in US Published Patent Application Nos. 2002/0009627 and 2004/0224204. A highly parallel indirect screening method has been developed, also primarily for fuel cell catalysts. The method and devices using the method rely on indicator molecules to provide an optical signal whose intensity is related to the extent of the reaction of interest, as disclosed in published international applications WO 2000/04362 and WO 2002/05367. As an indirect method, a single voltage source can be used to power the device and simultaneously probe a large number of catalyst samples. However, a clear line of vision of the reaction front is required, preventing the use of conventional cell designs and diminishing the accuracy of the screening method. Furthermore, there are also many electrochemical processes for which suitable indicator molecules have not been identified.

A combinatorial apparatus that screens individual catalyst samples has also been disclosed in US Published Patent Application No. US2006001430 using the IR signal related to the efficiency of each individual sample. However, preparation of the individual samples in series is time consuming and expensive and assembly of the cell and maintaining uniformity of operating conditions across all of the samples can be difficult.

Despite these advances, a combinatorial screening apparatus and method conducive to easy, low cost sample preparation for a wide range of electrochemical compositions over long periods of time and in conventional cell environments at a reasonable cost is needed.

### SUMMARY OF THE INVENTION

The present invention provides an apparatus and method to combinatorially screen a plurality of electrochemical material compositions for use in an electrochemical cell such as a fuel cell, battery or electro-catalytic cell. It also provides an apparatus and method to screen electrodes for uniformity of performance of an electrode of a single composition.

In one aspect of the invention an apparatus may comprise an electrochemical cell with one or more windows, sealed with an infrared (IR) transparent material for direct thermal imaging of an internal electrode, an electronic load for applying a voltage or current to the electrochemical cell, and a device, external to the cell, for monitoring the relative temperature of the internal electrode through each window of the cell when the load is applied. When a load is applied to the cell, the temperature observed through each window may be used as a relative measure of the electrochemical efficiency of the discreet region of the electrode being viewed and of the material compositions contained therein. The electrochemical cell may comprise discreet compositions of electrode materials. The electrochemical cell may be capable of being operated in a single fuel cell assembly. The electrochemical cell may further comprise catalysts. The catalysts may be a fuel cell catalysts. The catalysts may be applied to a carbon diffusion layer or to a membrane. The device for monitoring the temperature of the cells may be a thermal imaging device, infrared camera or array of thermocouples.

In another aspect of the invention, a combinatorial method for screening and evaluating electrochemical material compositions may be based on an indirect thermal signature related to the efficiency of discreet compositional regions of an electrochemical cell comprising the material compositions. The method may begin with the provision of the electrochemical material composition. The material may then be incorporated into a discreet region within the electrochemical cell. The next step may include the electrical connection of the cell. A potential or current may be applied to the electrochemical cell and the temperature associated with the discreet region of the cell monitored. The relative efficiency of the electrochemical material composition may be determined from the temperature measurements. The electrochemical materials may include catalysts. The catalysts may be incorporated into the cell by deposition onto the sample electrode. The deposition process may involve electrodeposition or may involve sputter deposition or may involve reductive reactions of metal salts. Salts may be applied to the electrode using known methods such as an ink jet plotter or other method. In one aspect of the invention the catalyst deposition process is used to create an electrode for combinatorial analysis that comprises a catalyst field with a continuous compositional, loading or morphological variation in any single direction across the electrode. The method may further include the compositional analysis of the materials before and after screening.

In yet another aspect of the invention, a method may involve screening an electrode of nominal uniform composition for variability in uniformity. The method may begin with providing an electrode for an electrochemical cell. The electrode is incorporated into an electrochemical cell between two conductive plates, one or more plates of which have discreet openings sealed with an IR transparent window for viewing discreet regions of the electrode. The next step may include electrical connection of the cell. A potential or current may be applied to the electrochemical cell and the temperature associated with each window for each discreet region of the cell monitored. The relative uniformity of the efficiency of the electrode may be determined from the variability of the temperature measurements.

Additional advantages of the invention will become readily apparent to those skilled in the art from the following detailed description, wherein only the preferred embodiments of the invention are shown and described, simply by way of illustration of the best mode contemplated for carrying out the invention. As will be realized, the invention is capable of other and different embodiments, and its details are capable of modifications in various obvious respects, all without departing from the invention. Accordingly, the drawings and description are to be regarded as illustrative in nature and not as restrictive.

### BRIEF DESCRIPTION OF THE DRAWINGS

FIG. 1 is a schematic representation of a first embodiment of the screening apparatus in accordance with the invention;

FIG. 2 is a schematic representation of a fuel cell assembly in accordance with this invention;

FIG. 3 is a cross-sectional view of the fuel cell assembly in accordance with the invention;

FIG. 4 is an illustration of a single electrode with continuous compositional variation for use in the invention;

FIG. 5 is a flow chart of a method for evaluating the uniformity of an electrode in accordance with the invention; and

FIG. 6 is a flow chart of a method for screening a plurality of electrochemical material compositions.

### DETAILED DESCRIPTION OF THE INVENTION

The present invention relates to the design of a new electrochemical screening device and methods for discovering and evaluating electro-catalysts and other electrochemical materials and for determining the electrochemical uniformity of an electrode of a single composition. The device comprises a number of separate parts including an electrode plate with an array of openings sealed with an IR transparent material, an electrochemical cell comprising an anode, a cathode and a membrane or separator, a single electronic load for applying a voltage or current to the cell, and an instrument for simultaneously monitoring the temperature of each electrode when the load is applied.

The device of the invention simultaneously monitors the equilibrium temperature of an array of discreet regions of an electrode defined by the portion of the electrode exposed by the IR transparent windows in the conductive electrode plate. The equilibrium temperature of each region of the electrode at any point in time during operation is dependent on the current passing through the electrode within that region, IX, and the electrode electrochemical resistance within that region, Rₓ. The equilibrium temperature is also dependent on the rate of heat loss from the cell to the surrounding environment. Assuming equilibrium conditions have been reached, the relationship between the temperature at each region and the current passing through it under constant voltage conditions can be described by the equation: ΔTₓ∝Pₓ=Iₓ²Rₓ=IₓVₓ=IₓV_{T}, where ΔTₓ is the temperature of the electrode region, x; Pₓ is the power associated with the electrode region; Iₓ is the current passing through the electrode region; Rₓ is the resistance of the electrode region; and Vₓ=V_{T} is the applied voltage to the entire cell. When a voltage is applied to the system, the temperature of the discreet regions of the electrode increases according to the relationship until the rate of heat generated at the cell is equal to the rate of heat loss from the cell. The resulting equilibrium temperature of each electrode region provides an indirect measurement of the relative efficiency of the materials comprising the electrode region. The device of the invention can be used to screen a large array of electrochemical material compositions to identify the compositions that exhibit the greatest electrochemical efficiency.

In one mode of operation, the apparatus may be utilized by applying a single voltage to a cell. The greatest current passes through the electrode region with the lowest effective resistance and greatest electrochemical efficiency. In the device of the invention, these more efficient electrode compositions are identified, external to the cell, by their proportionally greater increase in temperature. In one embodiment of the invention an infrared camera, external to the cell, monitors the temperature increase of discreet regions of the electrode through the infrared transparent windows.

For the purpose of this invention an electrochemical cell comprises two electrode layers, e.g., a cathode and an anode, where a chemical entity is oxidized or reduced respectively. The cathode and anode are separated by a membrane or separator. Either, both or neither the anode and cathode electrodes may comprise an array of compositions, loadings or morphologies. The electrochemical cell may also comprise a third, reference electrode. The electrochemical cell may also contain a membrane, which conducts ions but not electrons. The membrane may be a single-phase material such as the proton conductor, Nafion, or a multiphase material such as a porous polymer separator impregnated with a liquid electrolyte. An electrochemical material is any material that could be used in an electrochemical cell. Some examples of electrochemical materials include catalysts, active anode and cathode materials for battery, fuel cell and capacitor systems such as carbons, metals, alloys and metal oxides, membranes and separators, and electrolytes. Electrochemical processes that are of interest for screening include, electrocatalysis, intercalation, conversion reactions, double layer formation, and ion diffusion. The electronic load of the device is capable of both applying a constant voltage to the electrochemical cell and of monitoring the resulting current or of both applying a constant current to the electrochemical cell and of monitoring the resulting voltage. The temperature-monitoring instrument may be an IR camera or other thermal imaging device or an array of thermocouples or other device for measuring temperature.

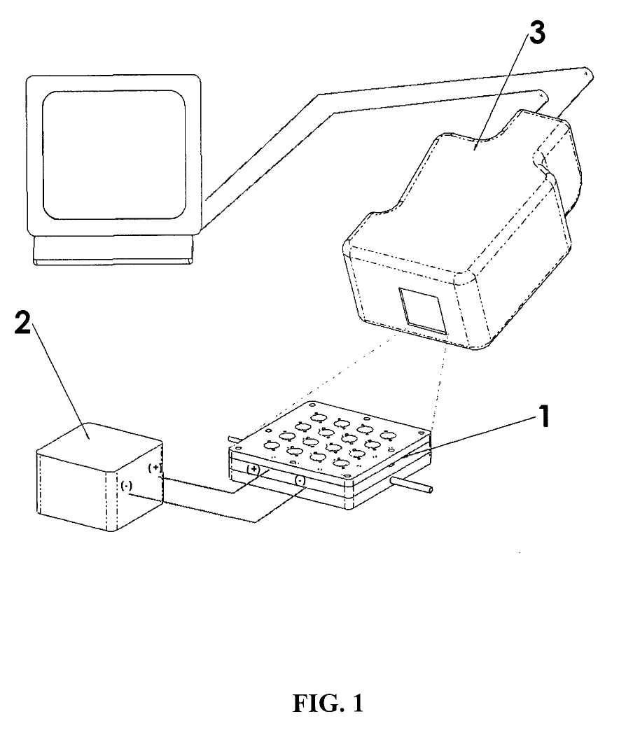

FIG. 1 shows a simple schematic of one embodiment of the present invention. An electrochemical cell body 1 comprises an array of IR transparent windows that allow for direct thermal imaging of an internal electrode surface. In this example, the working electrode is the positive cathode but it could also be the negative anode depending on the materials and electrochemical processes of interest. Each opening or window in the cell body defines an electrochemical region to be screened for electrochemical performance. In one aspect of the invention the electrode being viewed is a single continuous electrode. In another aspect of this invention the electrode being view may comprise an array electrode regions. The counter electrode, or in this example the negative anode, may comprise one or more common electrodes of the same material composition. The one or more electrodes comprising the counter electrode of the electrochemical cell body 1 are electrically connected to each other. The working electrode and counter electrode of the electrochemical cell body 1 may be separated by an ion conducting but insulating membrane or separator. For the purpose of this invention, when the apparatus is operated as a fuel cell, the working electrode-membrane-counter electrode unit may be referred to as a membrane electrode assembly or MEA. An MEA may also contain a gas diffusion layer, for example carbon cloth, adjacent each electrode for uniform fuel distribution. The working electrode and counter electrode of the electrochemical cell body 1 may be connected to a single electronic load 2 that applies a constant current or voltage. An IR camera 3 or other device for measuring and recording temperature may be located adjacent to the electrochemical cell body 1 for simultaneous monitoring of the temperatures of the electrode regions viewed through the cell body windows. The electronic load 2 may apply a constant voltage or current to the electrochemical cell body 1 and the electrode regions may increase in temperature according to their inherent efficiency as determined by many factors including the catalyst composition, loading and morphology. The temperature change vs. time of the electrode regions may be observed through the IR transparent windows of the electrochemical cell body 1 and recorded by the IR camera 3.

The invention has several advantages over current combinatorial screening methods used for electrochemical systems. Unlike other indirect screening methods for electrochemical systems, the temperature of the electrode regions can be monitored external to the cell, allowing for the use of conventional cell structures and designs within the cell body for more accurate evaluation of the materials of interest. The present invention may also be effectively scaled up to increase screening resolution, or to increase the sample variation with little corresponding increase in cost and complexity because there is no need for additional electrodes or additional leads and current monitoring channels.

Thus the combinatorial screening apparatus and methods of this invention allow long term testing of new electrochemical materials to be performed more efficiently and accurately in conventional cell environments at much lower cost for equipment and labor. The same apparatus can be used to determine the uniformity of any aspect of the electrode that may result in variations in the performance efficiency of the electrode across its face under normal operating conditions. Examples of parameters of an electrode that may vary, resulting in non-uniform performance include the catalyst loading, composition or morphology, the mixing quality, the electrode thickness and adhesion to the membrane. To our knowledge no other current apparatus provides a method for in-situ evaluation of the uniformity of an MEA.

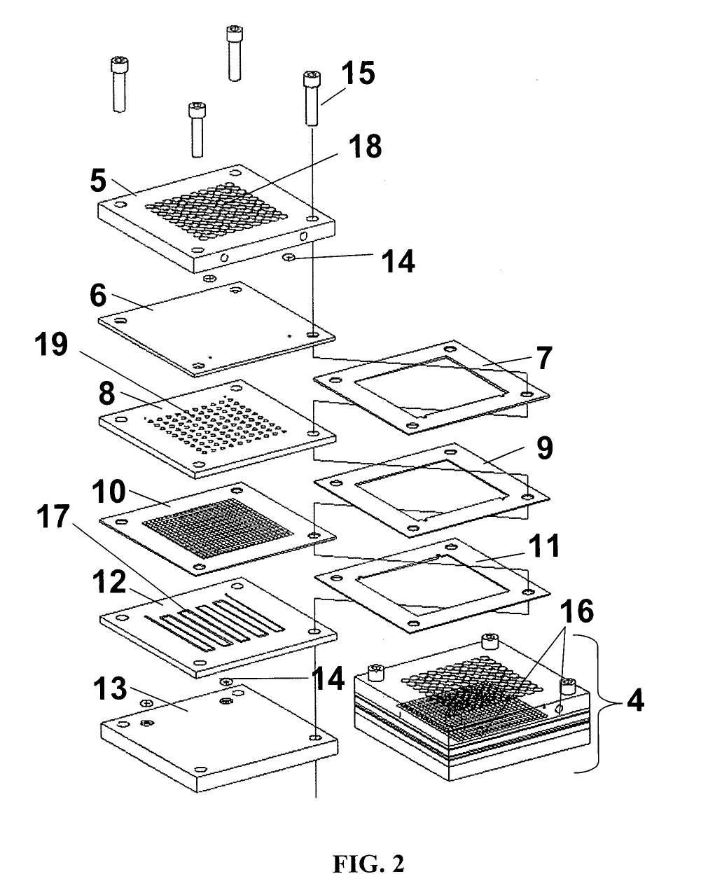

While not limited to a specific electrochemical reaction or material type, the device of the invention is particularly suited for screening electrochemical catalysts for fuel cells. A preferred embodiment of the invention comprises a fuel cell body with multiple IR-transparent windows for direct viewing of the internal fuel cell electrode or electrodes. A schematic of the fuel cell body 4 of the present invention and its components is shown in FIG. 2. In this embodiment, the cell body design is such that the working electrode half of the cell allows for thermal monitoring of the working electrode from outside of the cell using a thermal imaging device, while the counter electrode half of the cell comprises conventional fuel cell designs. The top plate 5 of the working electrode half of the cell may comprise a rigid material with an array of openings or windows 18. The top plate 5 may also comprise an inlet and outlet 16 for fuel flow to the electrode or MEA 10. Adjacent to the top plate may be O-ring gaskets 14 to allow for the inflow and outflow of fuel and reaction products to and from the electrode without leaks. Adjacent to the O-ring gaskets 14 may be a gas tight infrared (IR) transparent window layer 6, which may be a crystalline or glass solid that is transparent to IR radiation, or may be a polymer that is transparent to IR radiation. Some examples of materials that may be used for the IR transparent window layer include ZnS, ZnSe, Ge, polyethylene, and polypropylene. Adjacent the IR window layer may be a gasket 7 to prevent fuel leaks around the window. In one preferred embodiment, the gasket 7 may encompass the entire face of the IR window layer 6 and comprise an array of holes in line with the array of holes 18 of the top plate 5 and the holes 19 of an adjacent fuel flow plate 8 to prevent cross-flow of fuel from one fuel flow channel to another while maintaining a clear line of sight to the electrode through the IR transparent window openings. Adjacent the gasket 7 may be the fuel flow plate 8, which may comprise a fuel flow field made of channels cut into the fuel flow plate 8 on the electrode side or bottom side of the plate 8 for feeding and distributing fuel uniformly to the electrode 10. In one embodiment of the invention the plate 8 is made of graphite. The plate 8 may comprise an array of holes in line with holes in the top plate 5 and holes in the gasket 7 to provide an unimpeded view of the electrode or MEA 10 below from the outside of the cell 4, through the IR transparent layer 6. In one aspect of the invention the holes in the graphite plate 8 are positioned within the center of the channels of the fuel flow field without connecting one channel to another. Adjacent the fuel flow plate 8 may be a gasket 9 for sealing to the MEA 10.

For the purpose of the invention, the MEA 10 includes the component of the fuel cell that contains the electrolyte system sandwiched between two catalytic layers. The electrolyte system may include a matrix that supports a liquid phase electrolyte or a polymer phase. The catalyst layers may comprise a carbon diffusion layer and electrolyte phase. The catalyst could be a powder dispersed within a mixed phase carbon diffusion and electrolyte layer or it may be in the form of a thin film applied to the sample electrode or to the membrane. The MEA 10 may be positioned between the fuel flow plate 8 and a counter electrode fuel flow plate 12 while the gasket 9 and a second gasket 11 may provide an airtight seal between the fuel flow plate 8 and the counter electrode fuel flow plate 12 and the MEA 10. Fuel flow fields 17 of the fuel flow plate 10 and of the counter electrode fuel flow plate 12 may face the electrodes of the MEA 10. The remainder of the fuel cell block, comprising the counter electrode half of the cell, may be a mirror image of the working electrode side, or may comprise a conventional fuel cell design with no IR transparent windows as illustrated in FIG. 2. In this embodiment, the counter electrode fuel flow plate 12 and a base plate 13 have no openings and there is no IR transparent layer.

The electrode blocks may be assembled facing each other to form a self-contained, closed fuel cell. The components of the fuel cell body are held together by bolts 15 that pass through the four corners of the cell electrode blocks. The bolts must be electrically insulated from the plates so that the cell electrodes are not shorted. The gaskets 7, 9 and 11 may provide an airtight seal between the counter electrode block and the working electrode block and the ion conducting membrane, which can withstand mild pressures of up to 20 psi.

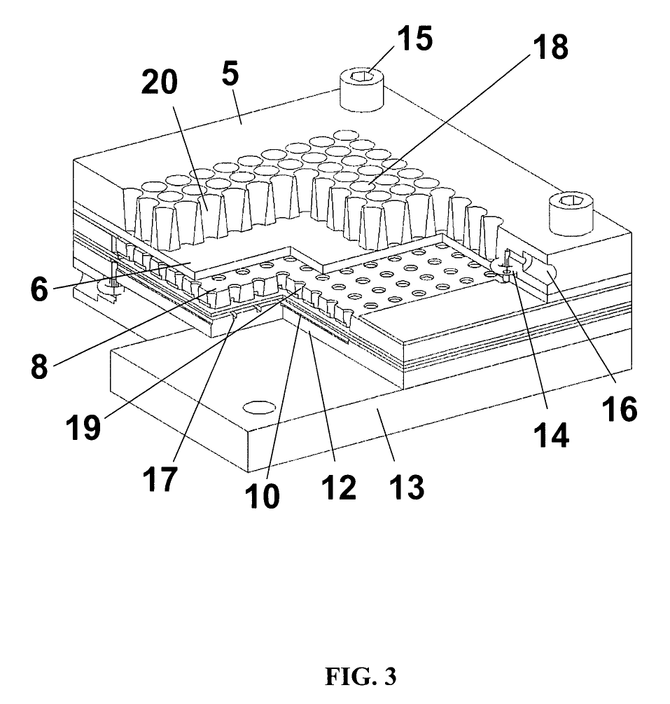

A cross-sectional view of the cell body 4 of one embodiment of this invention is shown in FIG. 3. In this embodiment, the IR windows 20 of the window array may be conical in shape with the outer window opening diameter being 2-10 times the diameter of the opening at the electrode face to provide a uniform field of view through each window across the array of windows at distances further away from the cell body. When assembled fuel may be fed into the cell body to the electrode or electrodes facing a window array by following a path through a fuel inlet 16, through the IR transparent window 6, through the fuel flow plate 8, into the fuel flow channels 17, to be distributed across the electrodes of the MEA 10. The MEA may include a gas diffusion layer adjacent the electrode to ensure uniform distribution of fuel across the electrode. Fuel flow to the other side of the MEA 10 follows a similar path. The fuel flow path and internal cell body may be sealed by the gasket layers 7, 9 and 11 to prevent leakage and crossover of the anode and cathode fuels. Fuel flow and distribution to the electrodes is identical or closely similar to methods used in conventional fuel cells. Therefore, the conditions and environment that may affect the performance of an MEA or the components of an MEA in the apparatus of this invention should be essentially identical to the conditions and environment the same MEA would experience if evaluated in a conventional fuel cell. The fuel cell of this invention may adopt most aspects of conventional fuel cell designs with the exception of an array of IR transparent windows for directly viewing the electrode. In this way, the design is easily scaled and the operation and performance of the fuel cell is essentially the same as the operation of any conventional fuel cell. Thus a standard MEA structure is used and can be screened for uniformity of performance.

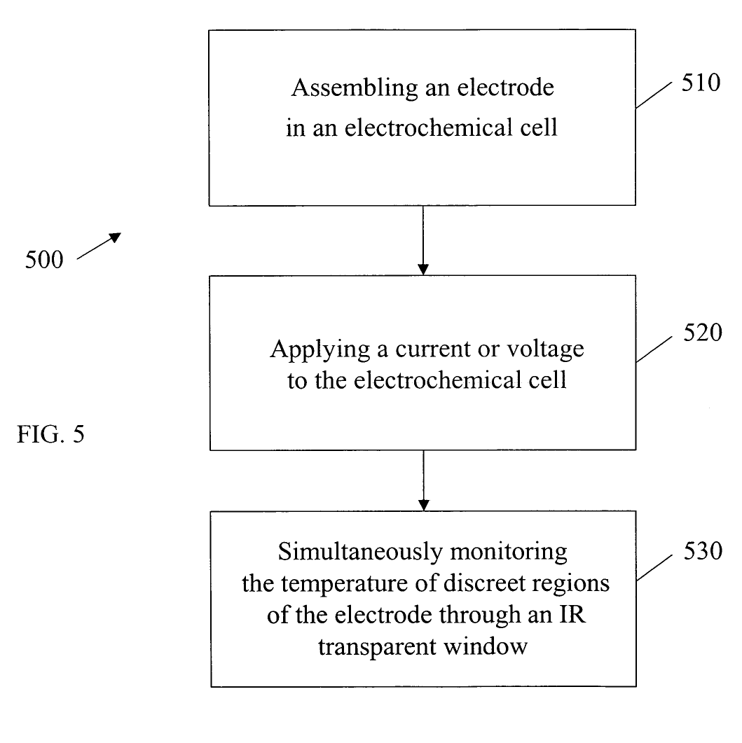

In an aspect of the invention, a method 500 (FIG. 5) for evaluating the uniformity of an electrode includes a step 510 of assembling the electrode in an electrochemical cell, a step 520 of applying a current or voltage to the electrochemical cell, and a step 530 of simultaneously monitoring the temperature of discreet regions of the electrode through an IR transparent window.

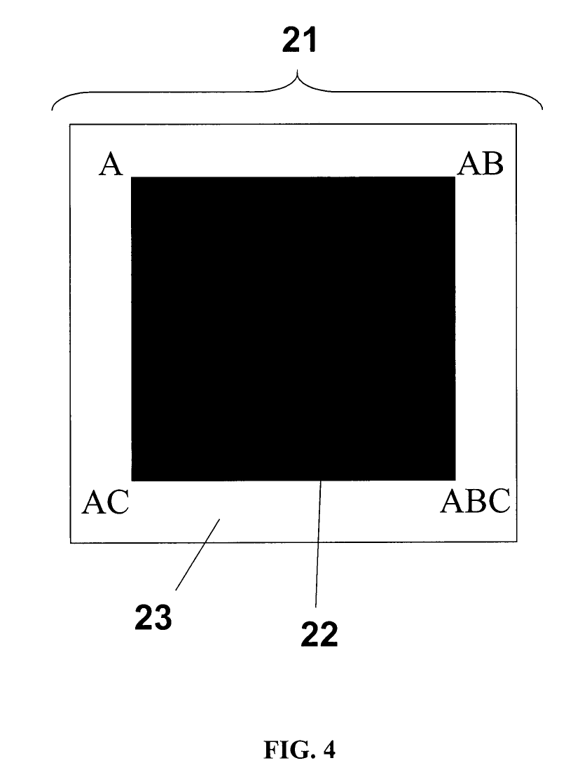

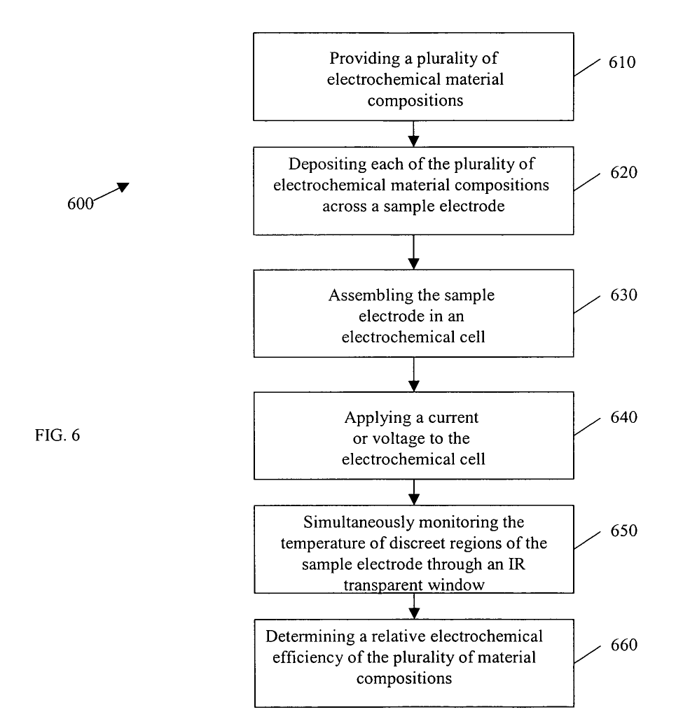

In another aspect of the invention, a method 600 (FIG. 6) for screening electrochemical materials may include providing a plurality of electrochemical material compositions (610) for screening followed by depositing each material composition on a working electrode in line with an IR transparent window of the electrochemical cell (620). The electrochemical material compositions may be arranged on an electrode as single discreet compositions without direct physical contact to each other and each within view of an IR transparent window, or, for example, as a continuously varying composition across the full electrode, in which the IR transparent windows encompass more than a single discreet phase. FIG. 4 illustrates an electrode comprised of a continuously varying composition, for example a family of electrochemical materials comprising elements A, B and C, that may be used in the screening apparatus.

In one aspect of the invention, catalytic compositions for evaluation in the fuel cell apparatus of the invention may be prepared and evaluated in a number of ways. The catalyst samples may be prepared by a number of methods including mechanical milling, precipitation reactions on a carbon support, hydrogen reduction of metal salts, microwave processing, and electrodeposition or sputtering. The catalyst may be applied to the electrode by many methods. In some aspects of the invention the catalyst can be applied to the electrode directly during synthesis, for example by sputter deposition, electrodeposition or reduction of metal salts. Powdered forms of the catalyst compositions of interest may be evaluated. For example, a powdered catalyst made by precipitation processes or high energy milling processes may be applied to carbon paper or directly to the membrane by making a slurry of the powdered catalyst with the electrolyte and a conductive additive. The slurry may be applied to carbon paper or to the Nafion membrane and the solvent removed by evaporation. The carbon paper supports for the different compositions may be applied in an array to the Nafion membrane and laminated to create a single electrode with an array of catalyst compositions.

The next step in the method 600 of the invention may include placing the electrode or MEA in the apparatus of this invention (630). After the cell has been assembled, a single electrical load may be connected to the positive and negative leads of the cell body and used to apply a voltage or current to the cell (640). The last two steps in the method 600 of the invention involve simultaneously monitoring the temperature increase of the electrode regions through the IR transparent windows after a load is applied (650) and using the temperature changes observed within each window to determine the relative electrochemical efficiency of the material compositions being screened (660). The temperature of the electrode under polarization is monitored external to the fuel cell body with an IR camera or other heat-sensing device. The differences of heating observed within the windows allow for the compositional region of greatest efficiency to be identified. An additional step in screening may involve creating a new electrode with less compositional variation focused on compositions that showed the best performance in the previous screening run. This step may be repeated until the best catalyst composition is identified. Furthermore, EDS or other compositional analysis tools can be used to identify and characterize regions of interest to determine what composition is giving the best performance.

In one embodiment of this method, a single electrode for use in the screening apparatus of this invention might have a variable composition across it. In one embodiment of this invention, illustrated in FIG. 4, the electrode 22 with continuous compositional variation is part of a fuel cell MEA 21 assembled using a Nafion or other ion conductive membrane 23. The electrode with continuous compositional variation may be prepared in a number of ways, such as by sputter deposition, printing techniques followed by reduction of the printed salt compositions. The electrode may be placed in the apparatus of this invention and the relative performance of discreet regions of the electrode may be determined by the amount of heat generated and imaged or otherwise measured through the IR transparent window array once a load is applied to the cell. The thermal signal observed through each window is a function of the average electrochemical efficiency of all compositional phases present within the region defined by the viewing window.

In one aspect of the method, subsequent electrodes of the same type prepared with less compositional variation but of the same physical size allow for further refinement of the catalyst compositions until the best catalysts are identified. In this way the method and apparatus of this invention provides a highly effective way of simultaneously screening, in-situ, an almost infinite array of catalyst compositions utilizing straightforward catalyst preparation techniques that is easily scaled without requiring additional complex parts or additional electrochemical monitoring channels.

In another aspect of the invention, a conventional MEA is used in the apparatus of this invention for the purpose of determining the uniformity of the electrode. Thus the apparatus may be used to control the quality of mass manufactured electrode and MEAs. There are a number of variables that can affect a fuel cell electrode's performance including the catalyst loading, the electrode density or porosity, and the degree of mixing of the components. In many cases, it is difficult to insure that any single electrode made is uniform in all of these properties across the entire electrode. Variability in these parameters will lead to differences in resistance across the electrode and therefore differences in current density and efficiency. Such differences and the resulting non-uniform current density within the cell can greatly affect the performance of the cell and lead to localized heating, unwanted side reactions and accelerated cell failure. When scaling up a process, it is critical that the electrodes be uniform throughout the entire device so as avoid any of these issues. However, screening the electrodes for uniformity related to its electrochemical performance is difficult to do since any test in a real cell environment only gives you the average performance for an electrode, with no real indication of its uniformity.

It must be emphasized that the example below is merely illustrative of specific embodiments of the invention and is not intended as an undue limitation on the generally broad scope of the invention. The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A combinatorial screening apparatus for electrochemical materials comprising:
an electrochemical cell with one or more infrared transparent windows; and
a device operable to monitor relative temperature changes of discreet regions of an electrode in the electrochemical cell arising from application of a potential or current to the electrochemical cell.

2. The apparatus of claim 1, wherein one electrode of the electrochemical cell comprises more than one discrete region characterized by different electrode parameters selected from the group consisting of composition, loading, porosity, and morphology.

3. The apparatus of claim 1, wherein one electrode of the electrochemical cell comprises a continuous variation of one or more parameters across the face of the electrode selected from the group consisting of composition, loading, porosity and morphology.

4. The apparatus of claim 1 wherein the electrodes of the electrochemical cell share a common membrane.

5. The apparatus of claim 1, wherein the electrochemical cell is a fuel cell.

6. The apparatus of claim 1, wherein the device comprises a thermal imaging device.

7. The apparatus of claim 1, wherein the IR transparent window opening is conical in shape.

8. The apparatus of claim 1, wherein the IR transparent window material is selected from the group consisting of high density polyethylene, ZnSe, ZnS, Ge, barium fluoride, calcium fluoride and IR transparent glass.

9. A method for screening a plurality of electrochemical material compositions comprising the steps of:
providing a plurality of electrochemical material compositions;
depositing each of the plurality of electrochemical material compositions across a sample electrode;
assembling the sample electrode in an electrochemical cell;
applying a current or voltage to the electrochemical cell;
simultaneously monitoring the temperature of discreet regions of the sample electrode through an IR transparent window; and
determining a relative electrochemical efficiency of the plurality of material compositions.

10. The method of claim 9, further comprising determining a relative electrochemical efficiency of the electrochemical material compositions from the monitored temperatures.

11. The method of claim 10, further comprising analyzing the electrochemical material compositions before and after determining the relative electrochemical efficiency of the electrochemical material compositions from the monitored temperatures.

12. The method of claim 9, wherein the electrochemical material compositions are catalysts.

13. The method of claim 9, further comprising depositing the electrochemical material compositions onto the electrode.

14. The method of claim 13, wherein the electrochemical material compositions are electroplated onto the sample electrode

15. The method of claim 13, wherein the electrochemical material compositions are sputter deposited onto the sample electrode.

16. The method of claim 13, wherein the electrochemical material compositions are applied to the electrode using printing methods.

17. A method for evaluating the uniformity of an electrode comprising the steps of:
assembling the electrode in an electrochemical cell;
applying a current or voltage to the electrochemical cell; and
simultaneously monitoring the temperature of discreet regions of the electrode through an IR transparent window.
